(19) United States
(12) Patent Application Publication
(10) Pub. No.: US 2020/0361497 A1
(43) Pub. Date: Nov. 19, 2020

(54) IDENTIFICATION SYSTEM, DEVICE, AND METHODS FOR USE WITH A DELIVERY SERVICE

(71) Applicant: JERS Tech, LLC, Tappan, NY (US)

(72) Inventors: Stephen Hoppe, Closter, NJ (US); Richard Altemus, Encino, CA (US); Jesse Campo, Encino, CA (US); Eric Arndt, Newark, DE (US)

(73) Assignee: JERS Tech, LLC, Tappan, NY (US)

(21) Appl. No.: 16/888,828

(22) Filed: May 31, 2020

Related U.S. Application Data
(63) Continuation-in-part of application No. 15/999,130, filed on Aug. 17, 2018, now Pat. No. 10,672,365.

(51) Int. Cl. B60W 60/00; G05D 1/02; G05D 1/00; G06Q 10/08; H04W 4/021; H04W 4/02; H04W 4/40

(52) U.S. Cl. CPC B60W 60/00256; G05D 1/0234; G05D 1/0022; H04W 4/40; G06Q 10/08355; H04W 4/021; H04W 4/023; G06Q 10/0832

(57) ABSTRACT

The system includes an electronic identification device operating in communication over a network with a software application. The approach includes hardware and software to communicate, signal and clearly identify the location of a delivery customer or delivery agent. Various components of the embodiments include wireless communication, enabled hardware, RF technology, web application software and network connectivity. A programmable electronic device syncs with another device and through internet connectivity to provide a perceptible signal. The approach can be used in connection with the delivery of goods or services, to inform services exactly where they are going and clearly indicate a corresponding delivery agent for any other purpose.

### RELATED APPLICATIONS

This application is a continuation-in-part and claims benefit under 35 U.S.C. § 120 of U.S. patent application Ser. No. 15/999,130 titled “ADDRESS LOCATION ASSISTANCE SYSTEM AND ASSOCIATED METHODS” filed Aug. 17, 2018 (Attorney Docket No. 3188.00004) which claims the benefit of U.S. Provisional Application No. 62/546,585 filed Aug. 17, 2017 the contents of each of which are incorporated by reference in their entireties except to the extent disclosure therein is inconsistent with disclosure herein.

### FIELD OF THE INVENTION

The present invention relates to systems and methods for assisting a delivery agent and/or delivery customer to locate each other.

### BACKGROUND

Various location assistance systems and devices are known. For example, The Global Positioning System (GPS) is a space-based radio-navigation system owned by the United States government and operated by the United States Air Force. It is a global navigation satellite system that provides geolocation and time information to a GPS receiver anywhere on or near the earth where there is an unobstructed line of sight to four or more GPS satellites.

The GPS system does not require the user to transmit any data, and it operates independently of any telephonic or internet reception, though these technologies can enhance the usefulness of the GPS positioning information.

Also, U.S. Published Patent Application No. 2015/0301150 to Stuckman et al. is directed to a delivery beacon device that is used by a customer to receive one or more drone deliveries. A user places the beacon device, which communicates via a network, in a desired delivery location at their service address. The beacon device generates a visible beacon that can be used by a drone delivery device or other delivery drone to more precisely locate the delivery location at the service address.

However, there is still a need for assistance to a delivery agent for delivery, emergency or other services to help easily identify an address or location and reduce time required to navigate and locate the address or location.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to systems, devices and methods for assisting a delivery agent or delivery customer to locate each other.

Embodiments are directed to a system, device and method to improve delivery location or delivery agent identification and includes an electronic identification device operating in communication over a network with a software application to assist response or delivery times of the delivery agent with reduced reliance on maps, phone calls or geo-location devices.

The approach includes hardware and software to communicate, signal and more clearly identify the location of a delivery customer or delivery agent. Various components of the embodiments include wireless communication (e.g. Bluetooth, Wi-Fi etc.) enabled hardware, RF technology, web application software and network (e.g. internet) connectivity. A programmable electronic device (e.g. LED, LCD or light board) syncs with another device (e.g. phone, tablet, computer via a router) and through internet connectivity to provide a perceptible signal, such as light, indicating the location, to a delivery agent or deliver customer, for example. The approach can be used in connection with the delivery of goods or services, to inform services exactly where they are going and clearly indicate a corresponding delivery agent for any other purpose, for example.

An embodiment is directed to an on-site location identification device for use with a delivery service system that includes a delivery agent instructed to locate a selected delivery location. The on-site location identification device includes a housing configured to be mounted at the selected delivery location, and a controllable electronic location identifier including a signal source, carried by the housing, and configured to communicate a location identifier. A control unit is coupled to the controllable electronic location identifier and configured to selectively control the controllable electronic location identifier to activate the signal source to vary at least one attribute of the location identifier to the delivery agent based upon a proximity of the delivery agent to the selected delivery location. A communication interface is coupled to the control unit and configured to communicate data with an external local user computing device, and a power unit is carried by the housing and configured to provide power to the controllable electronic location identifier, the control unit and the communication interface.

Additionally, and/or alternatively, the delivery agent comprises an unmanned vehicle comprising at least one of an autonomous delivery vehicle and a remotely operated vehicle. The unmanned vehicle may include a controllable delivery agent identifier configured to communicate a delivery agent identifier. The controllable delivery agent identifier may include a light controlled to vary at least one attribute based upon the proximity of a corresponding delivery customer to the delivery agent to increase perceptibility of the delivery agent identifier using visual effects via the light.

Additionally, and/or alternatively, the signal source of the controllable electronic location identifier may include a wireless signal transmitter or a light source. The control unit may be configured to selectively control the controllable electronic location identifier to increase perceptibility of the location identifier using visual effects via the light source.

Another embodiment is directed to a delivery service system operating over a network, and that includes the use of a delivery agent instructed to locate a selected delivery location. The system includes an on-site location identification device having a controllable electronic location identifier including a signal source, and configured to communicate a location identifier. A control unit is coupled to the controllable electronic location identifier and configured to selectively control the controllable electronic location identifier to activate the signal source to vary at least one attribute of the location identifier to the delivery agent based upon a proximity of the delivery agent to the selected delivery location. A communication interface is coupled to the control unit and configured to communicate data with an external local user computing device, and a power unit is configured to provide power to the controllable electronic location identifier, the control unit and the communication interface. A computing device running a delivery service application and including a wireless communication unit is configured to communicate delivery agent location proximity data with the display device.

Additionally, and/or alternatively, the delivery agent is an unmanned vehicle such as an autonomous delivery vehicle or a remotely operated vehicle. The unmanned vehicle may include a controllable delivery agent identifier configured to communicate a delivery agent identifier. The controllable delivery agent identifier may include a light controlled to vary at least one attribute based upon the proximity of a corresponding delivery customer to the delivery agent to increase perceptibility of the delivery agent identifier using visual effects via the light.

Additionally, and/or alternatively, the signal source of the controllable electronic location identifier may include a wireless signal transmitter or a light source.

Additionally, and/or alternatively, the control unit may be configured to selectively control the controllable electronic location identifier to increase perceptibility of the location identifier using visual effects via the light source.

Another embodiment is directed to a delivery service system operating over a network, and that includes the use of a delivery agent instructed to locate a selected delivery customer. The system includes a delivery agent identifying device including a controllable delivery agent identifier including a signal source, and configured to communicate a delivery agent identifier. A control unit is coupled to the controllable delivery agent identifier and is configured to selectively control the controllable delivery agent identifier to activate the signal source to vary at least one attribute of the delivery agent identifier to the delivery customer based upon a proximity of the delivery agent to the delivery customer. A communication interface is coupled to the control unit and configured to communicate data with an external local user computing device, and a power unit is configured to provide power to the controllable electronic location identifier, the control unit and the communication interface. A computing device runs a delivery service application and a geolocation application, and includes a wireless communication unit configured to communicate delivery customer location proximity data with the delivery agent identification device.

Additionally, and/or alternatively, the delivery agent comprises a drivered vehicle or an unmanned vehicle comprising at least one of an autonomous delivery vehicle and a remotely operated vehicle.

Additionally, and/or alternatively, the signal source of the controllable delivery agent identifier includes a light controlled to vary at least one attribute based upon the proximity of a corresponding delivery customer to the delivery agent to increase perceptibility of the delivery agent identifier using visual effects via the light.

Additionally, and/or alternatively, the control unit is configured to selectively control the controllable delivery agent identifier to increase perceptibility of the delivery agent identifier by displaying a matchable color that is communicated to the delivery customer. The control unit may be configured to selectively control the controllable delivery agent identifier to increase perceptibility of the delivery agent identifier by pulsing the light.

Additionally, and/or alternatively, the signal source of the controllable delivery agent identifier may include a wireless signal transmitter.

So, the embodiments of the invention can be used in connection with the delivery of goods or services, to inform delivery services exactly where they're going or inform the delivery customer which delivery agent corresponds to their order. A goal is to improve delivery times, response times and otherwise help identify a customer, delivery agent and/or location. The device may be mounted or otherwise positioned at the location or in the delivery agent vehicle via any appropriate mechanical feature.

### BRIEF DESCRIPTION OF THE DRAWINGS

FIG. 1 is a schematic illustration of a system and network with an identification device according to an embodiment of the present invention.

FIG. 2 is a schematic illustration of an identification device for use with the system of FIG. 1.

FIG. 3 is a schematic illustration of a user's house with an illuminated display device, according to an embodiment, of FIG. 2.

FIGS. 4A and 4B are a schematic illustrations of example user devices (client devices) for use with the system of FIG. 1.

FIGS. 5A and 5B are schematic illustrations of the delivery agent device linked to the identification device in the system of FIG. 1.

FIG. 6 is a schematic illustration of delivery agent identifying device in accordance with another embodiment of the present invention.

FIG. 7 is a schematic illustration of a system and network with a delivery agent identifying device in accordance with the embodiment of FIG. 6.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

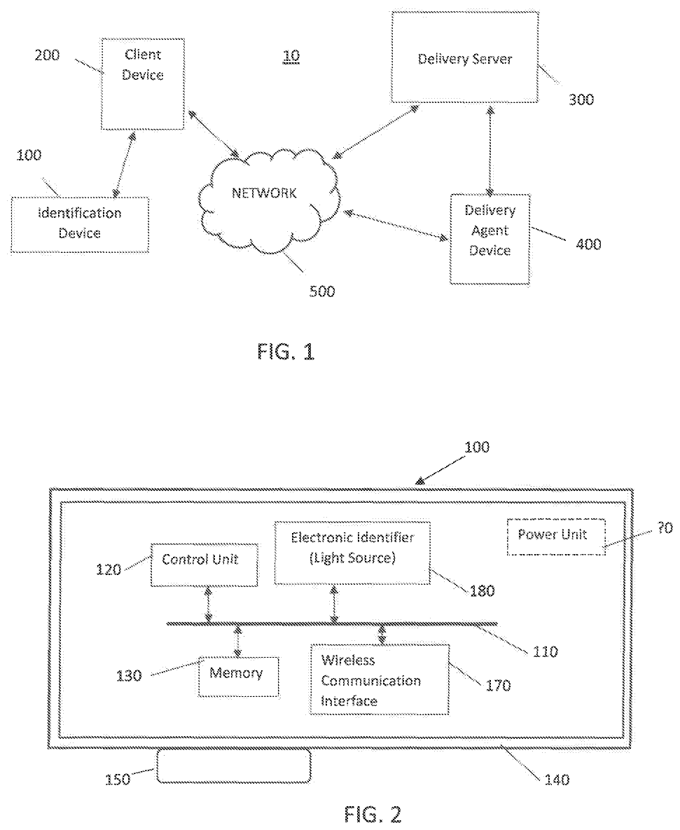

With reference to FIGS. 1-5, the system, device and method will be described. The inter-connected system or ecosystem may include an illuminated street address number sign, and applications that use wireless and wired network communications (e.g. local area network and internet connectivity), global positioning software, and network-based servers that aid human delivery and/or emergency services in the process of identifying a specific location. The illuminated street address number sign is capable of displaying the street address number(s) in association with specific global coordinates to help easily identify and reduce the time required to navigate to a particular location by human delivery services and/or emergency services.

The system, including the illuminated street address number sign, is capable of tracking the location of the human delivery/service driver (delivery and/or emergency service) that is requested by a user at a location. The ecosystem begins with a service request/order confirmed by the user through an application (e.g. web-based application) which is then acknowledged by the service through the network (including a network based server, for example) to begin communication with the illuminated street address number sign, and a mobile device application used by the driver to begin guidance to the location. Once the service request is ready to leave its origin, the driver is provided with a link via the network to the location through an application. The driver is then switched into route guidance through mapping software and the network may be then granted access to the location of the driver. The user device or display device is then provided with the location of the driver. Once the driver is within a certain proximity (predetermined distance as desired) of the location, the street address number sign will illuminate. When the driver is within visual range of the location, the sign may begin to pulse the lighted street address number to provide better awareness to the driver. Of course, other visual effects may be included in addition to or as an alternative to the pulsing.

The service may also be granted continual access to the location of the driver through the network to better manage the efficiency of the subsequent service requests the driver may receive and complete. The network may be capable of supporting the management of delivery/emergency service requests and can be customized to the needs of the service to work efficiently. Once the driver has completed the service request, the sign may power off or go into sleep mode.

As an option, when desired to support the driver in completing the service request, the user can be prompted through the application to authenticate, for example with a digital signature and/or fingerprint technology, through network which will confirm with a message (or symbol) on the driver device to securely leave the service request package at the location of the sign. A universally accepted symbol may be used as a way of approving any delivery service to leave a package without the need of signature.

The display device can be available in various designs to better suit its location both aesthetically and functionally. For example, the sign may include a hanging chain, window installation, base, or it may be mounted to a secure smart lock box to accept packages which will communicate through the network with the user via the application and user device.

FIG. 1 is a schematic illustration of a system 10 including a network 500 with an identification device 100, e.g. an illuminated display device or signal device, according to an embodiment of the present invention. A delivery server 300 and example devices, client device 200 and delivery agent device 400, operate in accordance with the present embodiments. The delivery server 300 communicates with a client device 200, such as a mobile terminal 210 or personal computer 220 (FIGS. 4A and 4B) via the network 500. The network 500 can include a single network or a plurality of different networks. These network(s) can include the Internet, a private communication network, a local area network, a mobile wireless communication network, a wired or fiber optic network or other broadband communication network, for example.

A delivery agent, with the associated delivery agent device, may be a drivered vehicle or an unmanned vehicle such as an autonomous delivery vehicle or a remotely operated vehicle.

The delivery server 300 can present a website that operates via a browser application of mobile terminal 210 and/or personal computer 220 or that otherwise provides a server application that operates in conjunction with a client device having an application such as a mobile application selected for download by the user and downloaded to the client device to present and gather delivery data that includes user data and delivery preferences, delivery location data that indicates a location for deliveries, delivery confirmation data and other data.

For example, a customer/subscriber can log into the delivery server 300 via an email address or other login ID, and password to access account information, enter preferences and payment information and other information pertaining to delivery services. In an embodiment, the delivery server 300 may communicate with one or more content servers corresponding to retailers that are the source of goods to be delivered. The content servers can include a map server that provides map data, image data such as sky view or street view data or other map or image data that is correlated to GPS coordinates or addresses.

FIG. 2 is a diagram of example components of an identification device 100. As shown in FIG. 2, device 100 may include a bus 110, a control unit or processor 120, a memory 130, a wireless communication interface 170 and an electronic identifier 180. A frame or housing (or any structural support for the components) 140 may carry or house the components, and a location mounting device 150 (e.g. bracket, hanger, stake, post, etc.) may be associated with the frame 140 to mount the frame at a delivery location. A power unit 160 provides power to the device 100. The power unit 160 may be a battery power unit, a solar power unit, and/or a wired power unit, or any other power interface that provides the needed power to the components.

An input component, such as a user input (e.g., components of a touch screen display, a keyboard, a keypad, a mouse, a button, a switch, a microphone, etc.), or a sensor for sensing information (e.g., a geo-location module such as a global positioning system (GPS) component, an accelerometer, a gyroscope, an actuator, etc.) may also be included. An output component may provide output information from device 100 (e.g., a speaker, one or more light-emitting diodes (LEDs), etc.). One or more antennas for wireless communication may also be included as would be appreciated by those skill in the art.

Bus 110 may include a component that permits communication among the components of device 100. Control unit 120 is implemented in hardware, firmware, or a combination of hardware and software. Control unit 120 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, control unit 120 may include one or more processors capable of being programmed to perform a function.

Such processors can include a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory 130. The memory can include a hard disc drive or other disc drive, read-only memory, random access memory, volatile memory, non-volatile memory, static memory, dynamic memory, flash memory, cache memory, and/or any device that stores digital information. Note that when a processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 110, other architectures are possible including additional data buses and/or direct connectivity between one or more elements. Further, the device 100 can include one or more additional elements that are not specifically shown.

Communication interface 170 may include a transceiver-like component (e.g., a transceiver, a separate receiver and transmitter, etc.) that enables device 100 to communicate with other devices, such as via a wired connection, a wireless connection, or a combination of wired and wireless connections. Communication interface 170 may permit device 100 to receive information from another device and/or provide information to another device. For example, communication interface 170 may include an Ethernet interface, an optical interface, a coaxial interface, an infrared interface, a radio frequency (RF) interface, a universal serial bus (USB) interface, a Wi-Fi interface, a cellular network interface, or the like.

The electronic identifier 180 may be a digital display, for example, an LCD, LED, plasma display, touch screen or any other digital display capable of communicating information including static characters or information as well as displaying images and/or video, for example. The electronic identifier 180 may also be a signal device configured to provide a signal to an unmanned delivery vehicle.

Device 100 may perform one or more processes described herein. Device 100 may perform these processes in response to the control unit 120 executing software instructions stored by a non-transitory computer-readable medium, such as memory 130 and/or another storage component. A computer-readable medium is defined herein as a non-transitory memory device. A memory device includes memory space within a single physical storage device or memory space spread across multiple physical storage devices.

Software instructions may be read into memory 130 from another computer-readable medium or from another device via communication interface 170. When executed, software instructions stored in memory 130 may cause control unit 120 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 100 may include additional components, fewer components, different components, or differently arranged components than those shown in FIG. 2. Additionally, or alternatively, a set of components (e.g., one or more components) of device 100 may perform one or more functions described as being performed by another set of components of device 100.

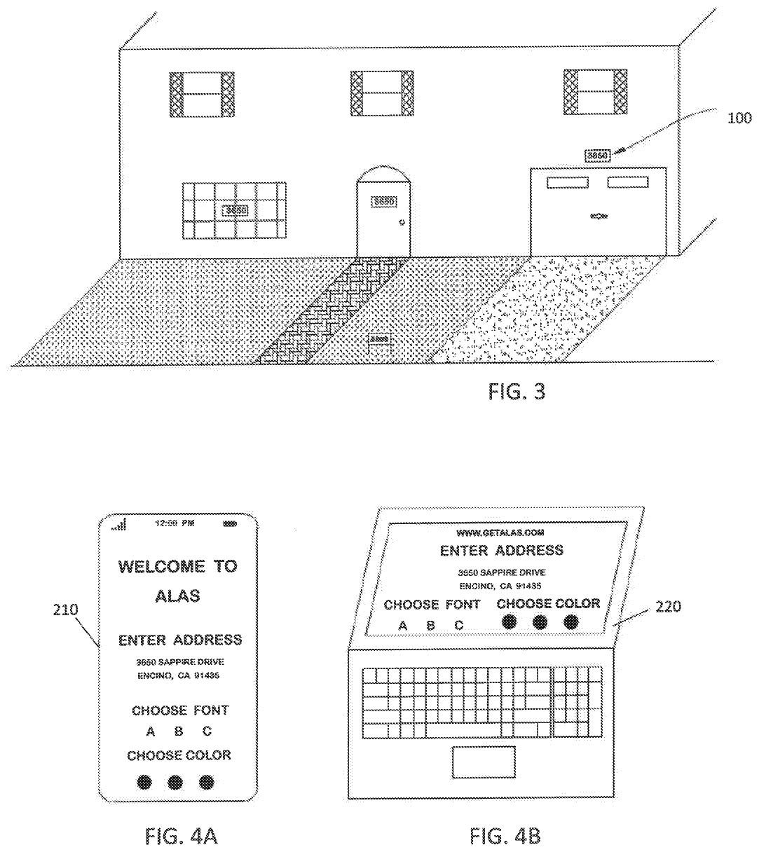

FIG. 3 is a schematic illustration of a user's house with the device 100 of FIG. 2 being an illuminated display device. The electronic identifier is a display 180 or illuminated street address number sign that is capable of displaying the street address number(s) in association with specific global positioning coordinates to help easily identify and reduce the time required to navigate to a particular location by human delivery driver and/or emergency services driver.

FIGS. 4A and 4B present example representations of a client device 200 in accordance with present embodiments. In particular, the client device 200 may be a mobile terminal 210, personal computer 20 or other client device such as a personal digital assistant, e-reader, tablet, or smartphone. The client device 200 may include a network interface such as a wireless interface such as a 3G, 4G, LTE or other wireless telephony transceiver, a Bluetooth transceiver, a WiFi transceiver, UltraWideBand transceiver, WIMAX transceiver, ZigBee transceiver or other wireless interface. Examples of interfaces further include wired interfaces such as a Universal Serial Bus (USB) interface, an IEEE 1394 Firewire interface, an Ethernet interface or other network card or modem for communicating with delivery server 300, or other servers. The client device 200 may also includes a user interface such as a display device, touch screen, key pad, touch pad, thumb wheel, one or more buttons, a speaker, a microphone, an accelerometer, gyroscope or other motion or position sensor, or other interface devices that provide information to a user of the client device 200 and that generate data in response to the user's interaction with the client device 200, as would be appreciated by those skilled in the art. In addition, the client device 100 may include an image capture device such as a digital camera that captures still or video images with or without associated audio.

The client device 200 may also include a processing module and associated memory module that stores an operating system such as a Linux-based operating system, a Microsoft personal computer or mobile operating system, an Android operating system, an Apple mobile or personal computer operating system or other operating system. The memory module may also store location data corresponding to the location of the client device 200 generated via user interaction, for example, via an optional Global Positioning System (GPS) receiver.

The client device may store a delivery client application which can be a general browser application such as Mozilla, Google Chrome, Safari, Internet Explorer or other general web browser or an application that is customized to operate in conjunction with delivery server 300 in conjunction with the exchange of delivery data.

FIGS. 4A and 4B present a graphical representation of screen display, for example, as generated by a delivery client application in response to delivery data from the delivery server. As shown, a set up screen may be presented to a user. Delivery location data received from the client device 200 indicates a service address associated with a user of the client device and a delivery location associated with the service address for receiving at least one delivery to the service address. The screen display is one in a number of different screen displays that guide the user in entering delivery location data and other data relating to delivery services for the user in conjunction with either a particular delivery or with respect to one or more future deliveries at a particular service address. It should be noted that the particular menu structure, screen layout and options are merely illustrative of the many types of delivery data that can be presented and could be selected in accordance with various present embodiments.

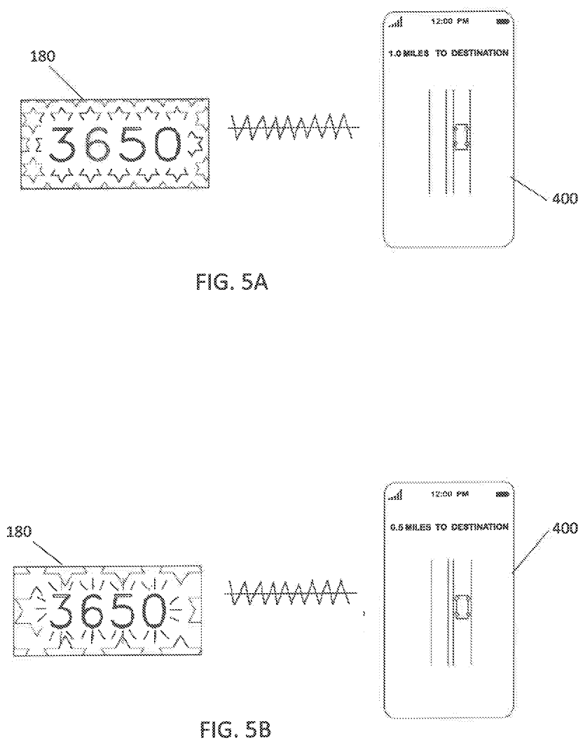

Referring additionally to FIGS. 5A and 5B, the client device 200 or display device 100 is provided with the location of the driver. Once the driver is within a certain proximity (predetermined distance as desired) of the location, the electronic identifier or display 180 (street address number sign) may be illuminated or increased in brightness of the light source, for example. When the driver using the delivery driver device 400 is within visual range of the location, the display 180 may begin to blink or pulse the lighted street address number to provide better awareness to the driver. Of course, other visual effects may be included in addition to or as an alternative to the blinking or pulsing.

Thus, the control unit 120 is coupled to the controllable electronic identifier 180 and configured to selectively control the controllable electronic identifier 180 to activate the signal source (e.g. light source or wireless signal) to vary at least one attribute of the location identifier to a delivery agent based upon a proximity of the delivery agent to the selected delivery location.

The sign, user device, network server, delivery system, delivery driver mobile device and other components may be part of, and/or communicate with, a smart-home system or network that may provide automated control of devices, appliances and other home systems (such as security systems, lighting systems, wired/wireless communication systems etc.), and may include the use of Internet of Things (IoT) technology, various input/output interfaces, Internet connectivity, and/or remote control capabilities etc., for example.

The sign, user device, network server, delivery system, delivery driver mobile device and other components may be implemented by one or more processors or computers. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Another embodiment will be described with additional reference to FIGS. 6 and 7.

FIG. 7 is a schematic illustration of a system 700 including a network 750 with an identification device 710, e.g. an illuminated display device or signal device as described above, and a delivery agent identifying device 600, according to an embodiment of the present invention. A delivery server 730 and example devices, client device 720 and delivery agent device 740, operate in accordance with the present embodiments. The delivery server 730 communicates with the client device 720, such as a mobile terminal or personal computer via the network 750. The network 750 can include a single network or a plurality of different networks. These network(s) can include the Internet, a private communication network, a local area network, a mobile wireless communication network, a wired or fiber optic network or other broadband communication network, for example.

A delivery agent, with the associated delivery agent device 740, may be a drivered vehicle or an unmanned vehicle such as an autonomous delivery vehicle or a remotely operated vehicle. The delivery agent device 740 may also be associated with a delivery agent identifying device 600.

The delivery server 730 can present a website that operates via a browser application of mobile terminal and/or personal computer or that otherwise provides a server application that operates in conjunction with a client device having an application such as a mobile application selected for download by the user and downloaded to the client device to present and gather delivery data that includes user data and delivery preferences, delivery location data that indicates a location for deliveries, delivery confirmation data and other data.

For example, a customer/subscriber can log into the delivery server 730 via an email address or other login ID, and password to access account information, enter preferences and payment information and other information pertaining to delivery services. In an embodiment, the delivery server 730 may communicate with one or more content servers corresponding to retailers that are the source of goods to be delivered. The content servers can include a map server that provides map data, image data such as sky view or street view data or other map or image data that is correlated to GPS coordinates or addresses.

The client device 720, delivery agent device 740 and the delivery server may individually or collectively run geolocation applications and delivery service applications to coordinate the delivery of goods to the customers. Each of the devices and server may communicate with each other over the network and via Application Programming interfaces (APIs), as would be appreciated by those skilled in the art.

FIG. 6 is a diagram of example components of the delivery agent identifying device 600. As shown in FIG. 6, device 600 may include a bus 610, a control unit or processor 620, a memory 630, a wireless communication interface 670 and an electronic identifier 680. The electronic identifier 680 may be a light-based signaling device. A frame or housing (or any structural support for the components) 640 may carry or house the components. A power unit 660 provides power to the device 600. The power unit 660 may be a battery power unit, a solar power unit, and/or a wired power unit, or any other power interface that provides the needed power to the components.

An input component, such as a user input (e.g., components of a touch screen display, a keyboard, a keypad, a mouse, a button, a switch, a microphone, etc.), or a sensor for sensing information (e.g., a geo-location module such as a global positioning system (GPS) component, an accelerometer, a gyroscope, an actuator, etc.) may also be included. An output component may provide output information from device 600 (e.g., a speaker, one or more light-emitting diodes (LEDs), etc.). One or more antennas for wireless communication may also be included as would be appreciated by those skill in the art.

Bus 610 may include a component that permits communication among the components of device 600. Control unit 620 is implemented in hardware, firmware, or a combination of hardware and software. Control unit 620 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, control unit 620 may include one or more processors capable of being programmed to perform a function.

Such processors can include a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory 630. The memory can include a hard disc drive or other disc drive, read-only memory, random access memory, volatile memory, non-volatile memory, static memory, dynamic memory, flash memory, cache memory, and/or any device that stores digital information. Note that when a processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 610, other architectures are possible including additional data buses and/or direct connectivity between one or more elements. Further, the device 600 can include one or more additional elements that are not specifically shown.

Communication interface 670 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

The electronic identifier 680 may be a light device or digital display, for example, an LCD, LED, plasma display, touch screen or any other digital display capable of communicating information including static characters or information as well as displaying images and/or video, for example. As such, the electronic identifier 680 may provide increased perceptibility of the delivery agent identifying device 600 using visual effects via light (e.g. selective colors) or unique images. The control unit 620 is coupled to the controllable delivery agent identifier 680 and is configured to selectively control the controllable delivery agent identifier 680 to activate the signal source to vary at least one attribute of the delivery agent identifier 600 to the delivery customer based upon a proximity of the delivery agent to the delivery customer.

The visual effects, color of light, or unique images that are being displayed by the delivery agent identifier 600, will also be communicated to the delivery customer via the network 750 and the client device 720. For example, the delivery customer would be notified to look for a blue light or a video image of a yellow banana being displayed by the delivery agent identifier 600 of the delivery agent. The delivery agent identifier 600 may be mounted anywhere within or on the delivery vehicle. This delivery agent identification approach may be useful in urban or other densely populated areas or events where many delivery agents may be operating simultaneously.

Device 600 may perform one or more processes described herein. Device 600 may perform these processes in response to the control unit 620 executing software instructions stored by a non-transitory computer-readable medium, such as memory 630 and/or another storage component. A computer-readable medium is defined herein as a non-transitory memory device. A memory device includes memory space within a single physical storage device or memory space spread across multiple physical storage devices.

Software instructions may be read into memory 630 from another computer-readable medium or from another device via communication interface 670. When executed, software instructions stored in memory 630 may cause control unit 620 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

That which is claimed is:

1. An on-site location identification device for use with a delivery service system that includes a delivery agent instructed to locate a selected delivery location, the on-site location identification device comprising:
a housing configured to be mounted at the selected delivery location;
a controllable electronic location identifier including a signal source, carried by the housing, and configured to communicate a location identifier;
a control unit coupled to the controllable electronic location identifier and configured to selectively control the controllable electronic location identifier to activate the signal source to vary at least one attribute of the location identifier to the delivery agent based upon a proximity of the delivery agent to the selected delivery location;
a communication interface coupled to the control unit and configured to communicate data with an external local user computing device; and
a power unit carried by the housing and configured to provide power to the controllable electronic location identifier, the control unit and the communication interface.

2. The on-site location identification device of claim 1, wherein the delivery agent comprises an unmanned vehicle comprising at least one of an autonomous delivery vehicle and a remotely operated vehicle.

3. The on-site location identification display device of claim 2, wherein the unmanned vehicle includes a controllable delivery agent identifier configured to communicate a delivery agent identifier.

4. The on-site location identification display device of claim 3, wherein the controllable delivery agent identifier includes a light controlled to vary at least one attribute based upon the proximity of a corresponding delivery customer to the delivery agent to increase perceptibility of the delivery agent identifier using visual effects via the light.

5. The on-site location identification display device of claim 1, wherein the signal source of the controllable electronic location identifier comprises a wireless signal transmitter.

6. The on-site location identification display device of claim 1, wherein the signal source of the controllable electronic location identifier comprises a light source.

7. The on-site location identification display device of claim 6, wherein the control unit is configured to selectively control the controllable electronic location identifier increase perceptibility of the location identifier using visual effects via the light source.

8. A delivery service system operating over a network, and that includes the use of a delivery agent instructed to locate a selected delivery location, the system comprising:
an on-site location identification device including
a controllable electronic location identifier including a signal source, and configured to communicate a location identifier,
a control unit coupled to the controllable electronic location identifier and configured to selectively control the controllable electronic location identifier to activate the signal source to vary at least one attribute of the location identifier to the delivery agent based upon a proximity of the delivery agent to the selected delivery location,
a communication interface coupled to the control unit and configured to communicate data with an external local user computing device, and
a power unit configured to provide power to the controllable electronic location identifier, the control unit and the communication interface; and
a computing device running a delivery service application and including a wireless communication unit configured to communicate delivery agent location proximity data with the display device.

9. The delivery service system of claim 8, wherein the delivery agent comprises an unmanned vehicle comprising at least one of an autonomous delivery vehicle and a remotely operated vehicle.

10. The delivery service system of claim 8, wherein the unmanned vehicle includes a controllable delivery agent identifier configured to communicate a delivery agent identifier.

11. The delivery service system of claim 10, wherein the controllable delivery agent identifier includes a light controlled to vary at least one attribute based upon the proximity of a corresponding delivery customer to the delivery agent to increase perceptibility of the delivery agent identifier using visual effects via the light.

12. The delivery service system of claim 8, wherein the signal source of the controllable electronic location identifier comprises a wireless signal transmitter.

13. The delivery service system of claim 8, wherein the signal source of the controllable electronic location identifier comprises a light source.

14. The delivery service system of claim 8, wherein the control unit is configured to selectively control the controllable electronic location identifier increase perceptibility of the location identifier using visual effects via the light source.

15. A delivery service system operating over a network, and that includes the use of a delivery agent instructed to locate a selected delivery customer, the system comprising:
a delivery agent identifying device including
a controllable delivery agent identifier including a signal source, and configured to communicate a delivery agent identifier,
a control unit coupled to the controllable delivery agent identifier and configured to selectively control the controllable delivery agent identifier to activate the signal source to vary at least one attribute of the delivery agent identifier to the delivery customer based upon a proximity of the delivery agent to the delivery customer,
a communication interface coupled to the control unit and configured to communicate data with an external local user computing device, and
a power unit configured to provide power to the controllable electronic location identifier, the control unit and the communication interface; and
a computing device, running a delivery service application and a geolocation application, and including a wireless communication unit configured to communicate delivery customer location proximity data with the delivery agent identification device.

16. The delivery service system of claim 15, wherein the delivery agent comprises a drivered vehicle or an unmanned vehicle comprising at least one of an autonomous delivery vehicle and a remotely operated vehicle.

17. The delivery service system of claim 15, wherein the signal source of the controllable delivery agent identifier includes a light controlled to vary at least one attribute based upon the proximity of a corresponding delivery customer to the delivery agent to increase perceptibility of the delivery agent identifier using visual effects via the light.

18. The delivery service system of claim 17, wherein the control unit is configured to selectively control the controllable delivery agent identifier to increase perceptibility of the delivery agent identifier by displaying a matchable color that is communicated to the delivery customer.

19. The delivery service system of claim 17, wherein the control unit is configured to selectively control the controllable delivery agent identifier increase perceptibility of the delivery agent identifier by pulsing the light.

20. The delivery service system of claim 15, wherein the signal source of the controllable delivery agent identifier comprises a wireless signal transmitter.
